(19) United States
(12) Patent Application Publication
(10) Pub. No.: US 2024/0109145 A1
(43) Pub. Date: Apr. 4, 2024

(54) WIRE FEEDER TO TORCH COMMUNICATION

(71) Applicant: ESAB AB, Gothenburg (SE)

(72) Inventors: Rodrigo Cesar Salum Machado, Onsala (SE); Oscar Eriksson, Vallda (SE)

(21) Appl. No.: 18/476,392

(22) Filed: Sep. 28, 2023

Related U.S. Application Data
(60) Provisional application No. 63/411,769, filed on Sep. 30, 2022.

(51) Int. Cl. B23K 9/095; B23K 9/10

(52) U.S. Cl. CPC B23K 9/0953; B23K 9/0956; B23K 9/1062

(57) ABSTRACT

A method for supporting communication between a torch and a wire feeder or power source. The method includes superimposing a carrier signal on a DC trigger line voltage that is modulated to communicate data between the torch and the wire feeder/power source. The circuitry also supports conventional trigger line functionality.

This application claims the benefit of U.S. Provisional Application No. 63/411,769, filed Sep. 30, 2022, which is incorporated herein by reference in its entirety.

### FIELD OF THE DISCLOSURE

The present disclosure relates generally to welding and cutting equipment and, more particularly, to communication between a torch and a power supply and/or a wire feeder of a welding or cutting system.

### BACKGROUND OF THE DISCLOSURE

A welding or plasma cutting torch is connected to a welding/cutting system via a torch cable that conveys several things to/from the torch. For example, in the case of Gas Metal Arc Welding (GMAW), e.g., Metal Inert Gas (MIG) welding, the torch cable supplies the welding wire advanced from a wire feeder, the main welding power used to perform the welding (or cutting) operation, and inert shielding gas. In a MIG torch, there is also often a trigger lever or button, which when depressed by a user, signals to the power supply and/or wire feeder, and gas control mechanism, to supply the main welding power, the welding wire, and the gas at a predetermined rate. A trigger signal wire (or pair of wires) is also typically included in the torch cable connecting the torch to the wire feeder or power supply to convey a trigger signal responsive to the trigger level or button being depressed.

### SUMMARY

In one embodiment, a method is provided and includes supplying, via communications wires, an electric signal between a welding module and a torch, monitoring the electric signal, in a first state, for a first type of power trigger signal received from the torch, monitoring the electric signal, in a second state, for a second type of power trigger signal, different from the first type of power trigger signal, from the torch, and in response to detecting the first type of power trigger signal or the second type of power signal, delivering welding or cutting type power to the torch.

In the method, the electric signal may be a DC signal.

In the method, the monitoring the electric signal, in the first state, may include detecting that the electric signal has been shorted.

In the method, the monitoring the electric signal, in the second state, may include detecting a repetitively modulated signal.

The method may further include electrically powering a human-machine interface of the torch with the electric signal.

In the method, the torch may include at least one display.

The method may further include superimposing a carrier signal on the electric signal.

The method may further include transmitting data to, and receiving data from, the torch via the carrier signal.

In the method, the carrier signal may be modulated using on-off keying, among other modulation techniques, to send the data.

In the method, the data may include a welding parameter.

The method may further include, in response to detecting the first type of power trigger signal or the second type of power trigger signal, delivering cutting type power to the torch.

An apparatus is also described and may include a power source, a torch, and communication wires connecting the power source and the torch, wherein the power source is configured to: supply, via the communications wires, an electric signal to the torch, monitor the electric signal, in a first state, for a first type of power trigger signal received from the torch, monitor the electric signal, in a second state, for a second type of power trigger signal, different from the first type of power trigger signal, from the torch, and in response to detecting the first type of power trigger signal or the second type of power signal, delivering welding or cutting type power to the torch.

### BRIEF DESCRIPTION OF THE DRAWINGS

By way of example, embodiments of the disclosed systems and methods will now be described, with reference to the accompanying drawings, in which:

FIG. 1 is a block diagram of a welding system, including communication circuitry, in accordance with an example embodiment.

FIGS. 2A, 2B and 2C show different types of torches that can operate with the torch communication circuitry, in accordance with an example embodiment.

FIG. 3 depicts interaction between, e.g., a human-machine interface (HMI) on a torch and backend systems of the welding system, in accordance with an example embodiment.

FIG. 4 depicts interaction between, e.g., a welding database and other devices of the welding system, in accordance with an example embodiment.

FIG. 5 is a block diagram of one embodiment of a system that enables the torch communication circuitry, in accordance with an example embodiment.

FIG. 6 is a graph showing effects of a trigger signal initiated at a torch and a corresponding enable signal supplied to a microcontroller of the torch communication circuitry, in accordance with an example embodiment.

FIG. 7 is a graph showing a torch trigger signal carried by a carrier signal that conveys data to and from the torch, in accordance with an example embodiment.

FIG. 8 is a graph showing on-off keying signals conveyed by the carrier signal, in accordance with an example embodiment.

FIG. 9 is flowchart showing a series of operations that may be performed or controlled by the welding system, in accordance with an example embodiment.

### DETAILED DESCRIPTION

As welding technology advances, there is an increasing desire to integrate a Human-Machine Interface (HMI), such as a graphical user interface (GUI)/display, with a torch to allow a user to send commands or information to a welding/cutting system (e.g., a power supply and/or a wire feeder) and/or to view information, supplied by, e.g., the welding/cutting system.

In this regard, and at a high level, disclosed herein are embodiments that, in one implementation, expand the functionality of normally-dedicated trigger wires that are disposed in a torch cable and that (conventionally) communicate only a trigger signal between a torch and, e.g., a wire feeder and/or power supply. In the embodiments described herein, those normally-dedicated trigger wires (hereinafter “communication wires”) not only provide legacy (conventional) trigger wire signaling, but also provide DC power and communication signals (i.e., data) for the torch's HMI.

In an embodiment, when a standard torch is connected to the system, the normally-dedicated trigger wires are used in a conventional manner to start/stop the welding/cutting operation. That is, in a traditional welding torch, without an additional communication capability or HMI, a DC supply voltage, e.g., 24V, is shorted by the trigger switch in the torch when the operator pushes the trigger button. Circuitry at the wire feeder (which may include the power source) detects the low voltage and interprets the same as a command to begin welding operations, i.e., supply welding or cutting type power. The embodiments described herein make use of the normally-dedicated trigger wires carried by the torch cable between the torch and wire feeder (or power supply) to add communication signals “on top of” the DC supply signal for torches that have digital HMI capabilities.

According to one implementation, the communication wires carry a 24V DC supply signal to power the HMI, and an on/off keying (OOK) modulation scheme of a high frequency carrier signal is used to convey data over the DC supply to the HMI. Notably, this scheme may be used to send data in both directions. In this manner, no new pins or wires are needed in the interconnection between the torch and the rest of the welding system, e.g., the wire feeder. It is noted that in a tungsten inert gas (TIG) welding system or in a cutting system, there is no feed wire (and thus no wire feeder), so the torch is connected via the torch cable directly to the power supply.

With regard to information that is conveyed via the communication scheme, the system, in one embodiment, may maintain a welding database, executing, e.g., in the power source, and HMI client components may execute in any of the system's HMIs (e.g., at the wire feeder, and/or at the torch). An HMI client can request an update to a setting parameter in the welding database, and may thereafter receive updates on any changed value. In one specific example involving a MIG welding system with a wire feeder, an operator may push a button on the torch to change the wire feed speed setting. This would result in a request to be sent from the torch HMI client over the communication wires to the wire feeder, and re-routed (in one possible implementation) over an Ethernet connection between the wire feeder and power source, where the welding database would receive the request. The power source, in communication with the welding database, then acts upon the change request and, after appropriate updating, sends an updated parameter value to all client HMIs (slaves) throughout the system, including the torch client HMI. In this case, a message may be sent from the power source via Ethernet to the wire feeder, and the wire feeder thereafter forwards the appropriate data via the communication wires to the torch HMI client.

In addition to setting parameters, synchronization signals regarding the system's state (e.g., startup, running, error, shutdown, etc.) can be conveyed over the communication wires, as well as information regarding error events/error codes generated throughout the system. According to one option, the use of the communication wires can be expanded to convey measurement data from the welding torch, such as temperature and other measurement metrics.

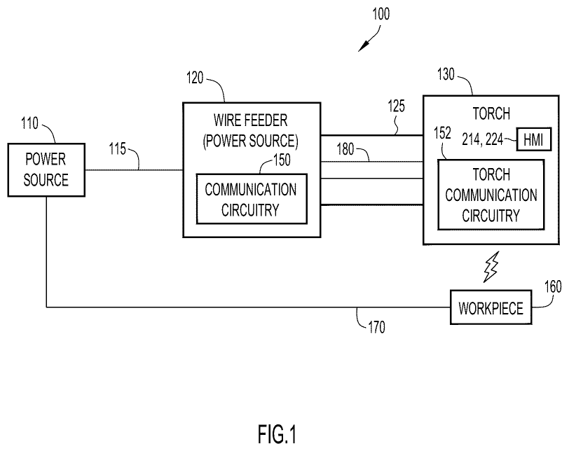

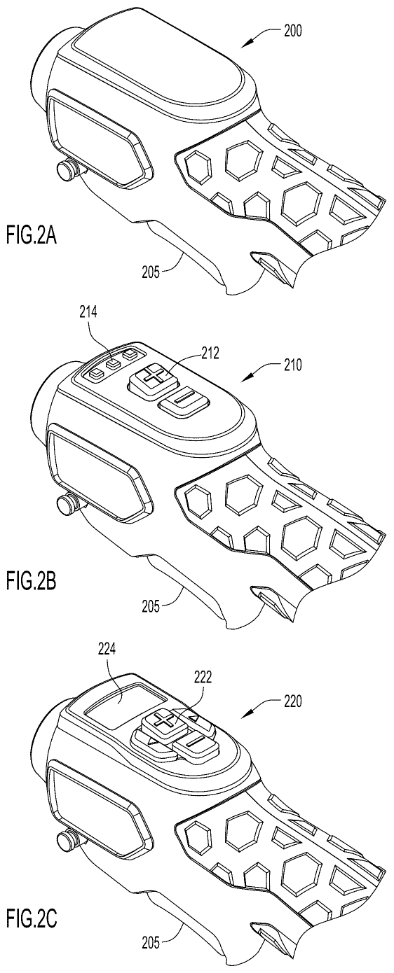

Reference is now made to FIG. 1, which is a block diagram of a welding system 100, including communication circuitry 150 and torch communication circuitry 152, in accordance with an example embodiment. More specifically, a power source 110, which is configured to generate welding or cutting power, is in communication, via link 115, with a wire feeder 120. Link 115 may include a welding power cable and communication cable, such as an Ethernet or Control Area Network (CAN) cable (not shown) to enable communication between the power source 110 and wire feeder 120. Wire feeder 120 includes communication circuitry 150, which is explained in more detail below. At a high level, communication circuitry 150 is configured to monitor communication wires 180 in torch cable 125 for a trigger signal, initiated at torch 130 (perhaps by torch communication circuitry 152), and, also in accordance with an embodiment, to enable data communication between wire feeder 120 and torch 130 to supply power and data to, e.g., a HMI 224 (FIG. 2C) on torch 130. Workpiece 160 is connected to a ground cable 170, and when an arc is generated between torch 130 and workpiece 160, and in well-known fashion, an electrical circuit is completed back to power source 110.

FIGS. 2A, 2B, and 2C show different types of torches that can operate with communication circuitry 150, in accordance with an example embodiment. Specifically, FIG. 2A shows a basic torch 200 with a single trigger switch 205, but no HMI. In this case, communication circuitry 150 is configured to monitor for a trigger signal, typically a low voltage (short circuit) signal, and in response, cause welding (or cutting) power to be supplied via wire feeder 120 to torch 200 such that welding (or cutting) can be performed. FIG. 2B shows an enhanced torch 210, which not only includes trigger switch 205, but also includes actuators or buttons 212 (e.g., to increase/decrease wire feed speed), and perhaps LEDs 214 to indicate system status information. FIG. 2C shows a HMI-display torch 220 that includes trigger switch 205, actuators or buttons 222 and a HMI 224 (e.g., a liquid crystal display (LCD)) on which can be displayed any number of welding process parameters. Actuators or buttons 222 may allow a user not only, e.g., to increase/decrease wire feed speed, but also to select desired information to be displayed on display 224, and to send additional parameter requests (e.g., desired voltage, desired current, etc.) back to wire feeder 120, via troch communication circuitry 152, communication wires 180 and communication circuitry 150, and perhaps link 115 to power supply 110.

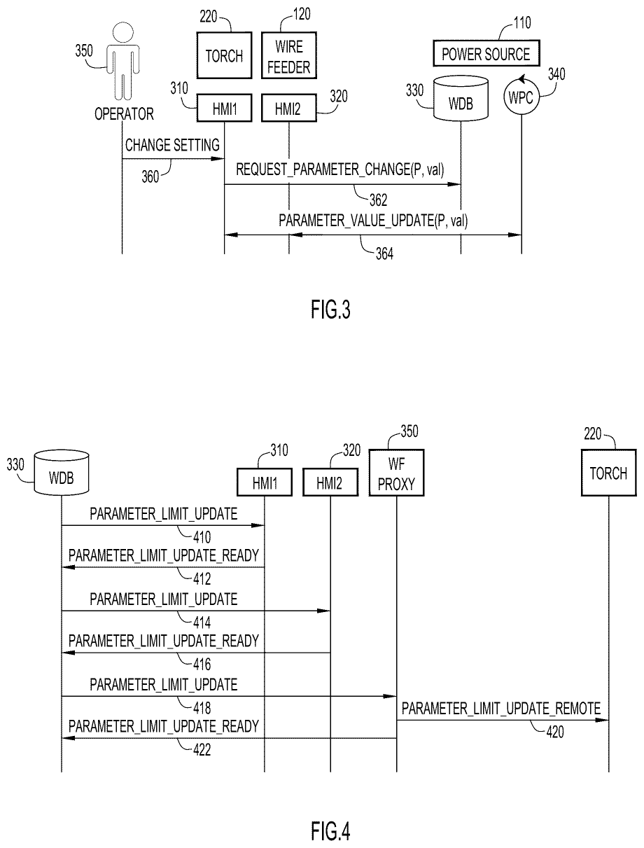

FIG. 3 depicts interaction between, e.g., a human-machine interface on HMI-display torch 220 of FIG. 2C (or torch 130 of FIG. 1) and backend systems of the welding system 100, in accordance with an example embodiment. As shown in FIG. 3, HMI-display torch 220 includes HMI1 310, and wire feeder 120 includes HMI2 320. A welding database (WDB) 330 and welding process controller (WPC) 340 may be disposed in power source 110. An operator 350 may choose to change a setting at 360, before or while welding, by interacting with HMI1 310 on HMI-display torch 220. HMI 310 may include, for example, a touch display 224 and/or buttons 222 that enable the interaction. The operator input to HMI1 310 is then configured as a REQUEST_PARAMETER_CHANGE message, with parameter P (e.g., voltage) and value val (e.g., 40 V) parameters, that is then sent at 362 to power source 110 and to WDB 330 via communications wires 180. WDB 330 registers the changes for the parameters and values, and then causes, at 364, a PARAMETER_VALUE_UPDATE message to be promulgated to system components such as HMI1 310, HMI2 320 at wire feeder 120 and WPC 340, which together control the overall welding process.

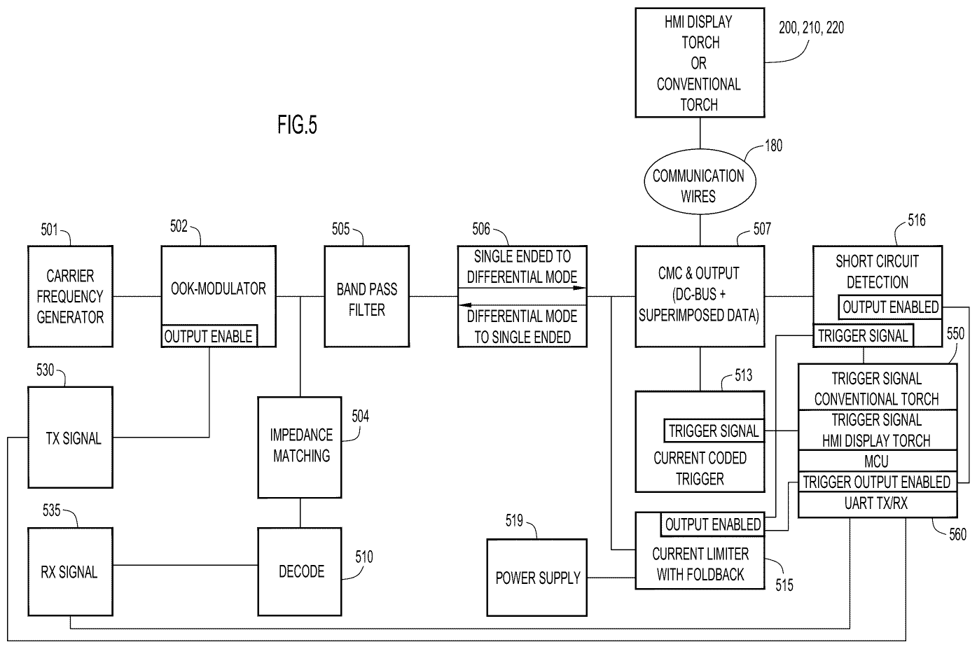

In a similar vein, FIG. 4 depicts the interaction between, e.g., WDB 330 and other devices of the welding system 100, in accordance with an example embodiment. In this example, WDB 310, and/or processing operation related thereto, sends parameter/value limits to multiple devices. Such parameter/value limits may have been updated in WDB 310 by a user, or automatically as a result of some weld process control operation. Specifically, at 410, WDB 330 sends a PARAMETER_LIMIT_UPDATE message to HMI1 310, and at 412, HMI1 310 sends a PARAMETER_LIMIT_UPDATE_READY message back to WDB 330. At 414, WDB 330 sends another PARAMETER_LIMIT_UPDATE message to HMI2 320, and at 416, HMI2 320 sends a PARAMETER_UPDATE_READY message back to WDB 330.

Still further, at 418, WDB 330 sends a PARAMETER_LIMIT_UPDATE message to wire feeder proxy 350. Wire feeder proxy 350 sends a PARAMETER_LIMIT_UPDATE_REMOTE message to torch HMI-display torch 220 at 420 to convey the limit to HMI-display torch 220. Thereafter, at 422 wire feeder proxy 350 sends a PARAMETER_LIMIT_UPDATE_READY message back to WDB 330 (perhaps in response to HMI-display torch 220 acknowledging receipt of the message).

In this way, WDB 330 can set limits on parameters/values that any given client HMI can select, given a particular welding or cutting process. For example, when welding system 100 is configured for a manual metal arc (MMA) welding process, the output weld current parameter may be controlled such that it is adjustable by a user from 12A to 500A. As another example, when welding system 100 is configured for a gas metal arc welding (GMAW) process, the wire feed speed values may be limited to adjustment between 0.8 m/min to 25 m/min.

FIG. 5 is a block diagram of one embodiment of the communication circuitry 150, in accordance with an example embodiment. Communication circuitry 150 may be implemented in wire feeder 120, as depicted in FIG. 1, but could also be implemented in power source 110, which could incorporate a wire feeder, or not have wire feeding functionality at all. Some of the functionality described below may also be implemented for torch communication circuitry 152, as is mentioned later herein.

As shown, the following blocks are provided.

Carrier frequency generator 501 may generate, e.g., a 6 MHz signal using, e.g., a relaxation oscillator based, e.g., on a high-speed comparator.

On-off keying (OOK) modulator 502 may be implemented with line drivers based on a signal received from MCU 550. Two parallel line drivers may be employed to boost output current capability to maximize signal amplitude. Clamp diodes and a bleeder resistor (not shown) may be used to reduce or avoid, e.g., ringing on signals when line driver outputs turn to a High-Z (i.e., high impedance state, i.e., when the carrier is turned off). OOK is only one possible example of a modulation technique. Other techniques such as frequency modulation (FM), amplitude modulation (AM), frequency shift keying (FSK), or amplitude shift keying (ASK), among others, could also be implemented.

Impedance matching 504 may be tuned for the characteristic cable impedance for communication wires 180 at the carrier frequency.

Band pass filter 505 may be provided for selective tuning of received (and transmitted) signals. The center frequency may be tuned for the carrier frequency with a small passband.

Single ended to differential mode converter 506 may be used where differential signaling is used over communication sires 180.

Common mode choke (CMC) and output 507 suppresses common-mode noise and prevents it from propagating into circuitry. Transient voltage suppressor (TVS) diodes may be used to clamp differential mode disturbances/voltage transients.

Decode module 510 may be comprised of two peak detector circuits: one fast detector on a comparator negative input and a slower one on the positive terminal. Hysteresis may be employed to avoid detection errors.

Current coded trigger 513 converts PWM carrier current (e.g., 1 kHz 10%˜100 mA peak) or a DC signal (among other signals indicative of a switch having been actuated) conveyed over communication wires 180 to stable on/off signal for trigger use. That is, current coded trigger 513 converts a coded trigger signal conveyed by the carrier from HMI-display torch 220 for use by MCU 550.

Current limiter with foldback 515 limits current supplied over communication wires 180.

Short circuit detection 516 is configured to detect conventional or traditional “short-circuit triggers.” The trigger signal is supplied to MCU 550. This component may also be used as a turn off signal for the DC-bus component on communication wires 180. That is, even if current limiter with foldback 515 would be enough to limit short-circuit current, this implementation adds further protection by disabling the DC-voltage output when a conventional trigger button is pressed. Trigger current may be configured to flow only through an optocoupler (for short circuit detection circuit) during the time when trigger switch 205 is pressed.

Power supply 519 supplies the DC (e.g., 24V) power for the trigger signal and carrier signal.

TX signal 530, under the control of MCU 550 and UART TX/RX 560, supplies an enable signal to OOK modulator 502 to convey data via the carrier.

RX signal 535 passes decoded data from decode module 510 to UART TX/RX 560 and MCU 550.

Micro controller unit (MCU) 550 is a processor configured to, among other things, generate enable signals in response to detected trigger signals, and transmit data to and receive data from HMI-display torch 220. MCU 550 includes a memory for storing instructions that may be executed by MCU 550 to perform or control various functions described herein. HMI-display torch 220 may also include a controller that is configured to receive and transmit data via communication wires 180.

Universal asynchronous receiver/transmitter (UART TX/RX) 560 is used to transmit and receive data via communication wires 180.

In one implementation, and at a high level, power supply 519 delivers, e.g., 24V over communication wires 180 and in one implementation has current capability of 150 mA to support a respective HMI of two different HMI-display torches 220, including power for a 100 mW LED and to support superposition of pulse current for trigger functionality.

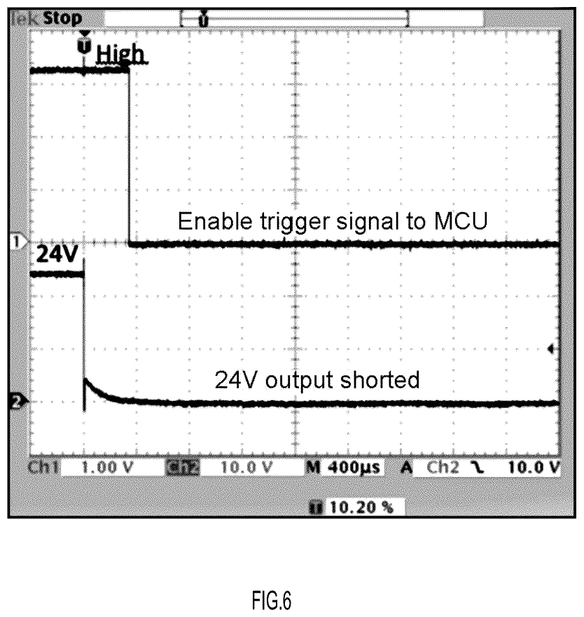

As noted, a conventional torch 200 includes a single trigger switch 205. Trigger switch 205 is typically configured to short-circuit the 24V supplied over communication wires 180. Circuitry of short-circuit detection 516 is configured to detect a low voltage level and, in response, to force an output low on a dedicated pin of micro controller (MCU) 550. FIG. 6 illustrates the transition. MCU 550, in combination with associated firmware/software, then, in response to a detected trigger, causes welding system to be in an active (e.g., welding, cutting) mode with, in one embodiment, a start-up time delay to prevent false triggering during state transitions.

In an embodiment, on off keying for TX signals 530 and RX signals vary between 3.3V and 0V. The 6 MHz carrier signal is superimposed on the 24V line when a TX signal is to be transmitted from MCU 550 to HMI-display torch 220.

That is, when it is desired to send data from MCU 550 to HMI-display torch 220, TX signal 530 enables/disables (on off keys) an output to modulate the carrier signal superimposed on the 24V line.

In an embodiment, electric power supply for HMI-display torch 220 is provided by the 24V power supplied over communication wires 180, and, e.g., a DC-DC converter may be used to generate the desired 3.3V for data processing, and data transmission from HMI-display torch 220.

When trigger switch of HMI-display torch 220 is pressed, HMI-display torch 220 is configured, in one possible implementation, to modulate the carrier at 1 kHz with 10% pulse width.

The 24V line is disposed in parallel with the welding circuitry and, as a result, high di/dt from the welding current might undesirably be injected in the communication data line/circuitry. As such, component selection may be driven by high common mode rejection characteristics. To minimize disturbances, common mode choke 507 may be used on the 24V line input at the wire feeder (or power supply), but, due to space constrains at the smart torch side, it is possible that no common mode data inductor (choke) is used.

Torch 130 (such as enhanced torch 210 or HMI-display torch 220), as depicted in FIG. 1 includes torch communication circuitry 152. To enable back and forth communication between communication circuitry 150 and torch communication circuitry 152, torch communication circuitry 152 may include components such as carrier frequency generator 501, OOK modulator 502, impedance matching 504, band pass filter 505, decode 510, TX signal 530 and RX signal 535, or similar components.

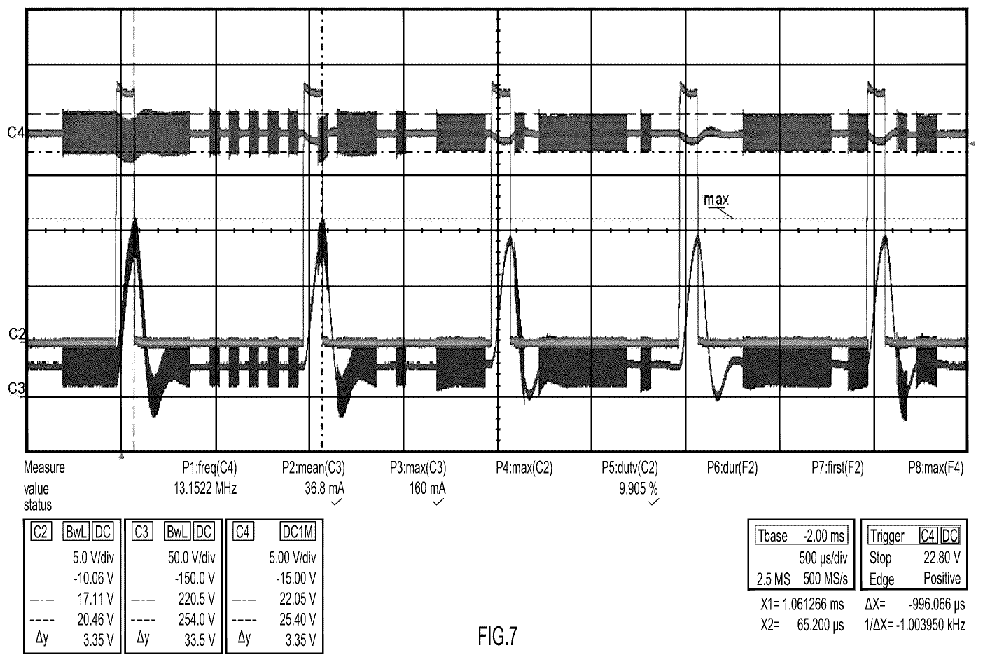

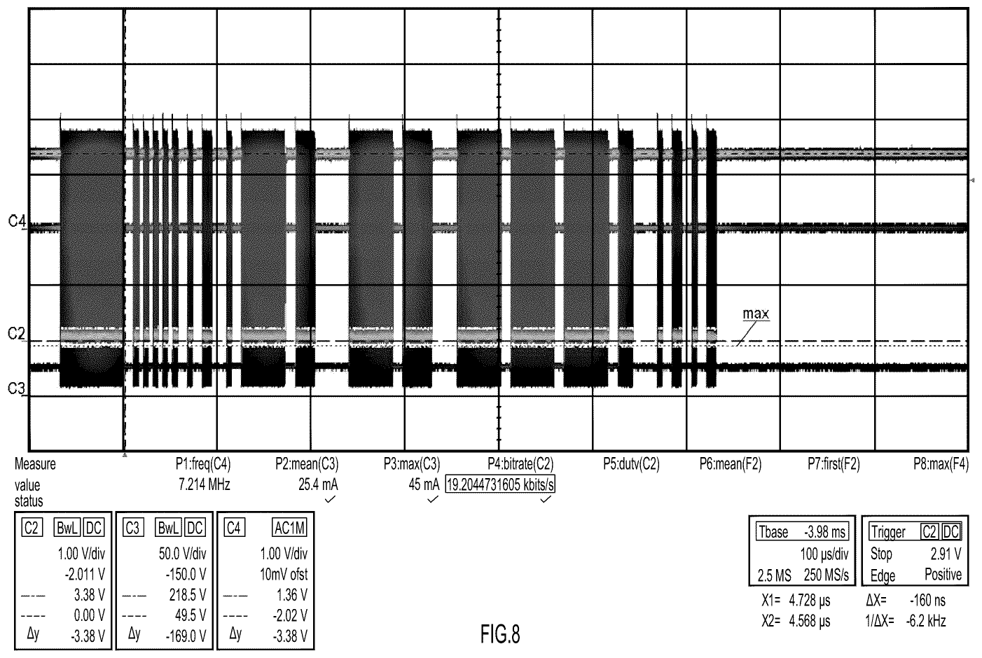

FIG. 7 shows an oscillogram where CH 4 illustrates superimposed data over a DC bus signal that is conveyed via communication wires 180. When trigger switch 205 is pressed at enhanced torch 210 or HMI-display torch 220, a 1 kHz 10% PWM is modulated to enable current coded trigger 513 as recorded by CH2 and CH3 respectively. As noted earlier, such a PWM signal is interpreted as a trigger to enable welding or cutting current from power source 110.

FIG. 8 illustrates a scenario where operator 350 upgrades software and/or changes a welding or cutting system setting for power source 110 via enhanced torch 210 or HMI-display torch 220, or HMI2 at wire feeder 120 sends data to enhanced torch 210 or HMI-display torch, or power source 110 sends data to HMI1 at enhanced torch 210 or HMI-display torch and HMI2 at wire feeder 120. For any such scenarios, CH 4 shows the AC component of superimposed data transferred via communication wires 180. The width of the carrier frequency recorded is due to TX signal 530 enabling the OOK-modulator 502. CH 2 is the RX signal 535 decoded by 510 showing data integrity. CH 3 shows current consumption by communication wires 180 during data transfer.

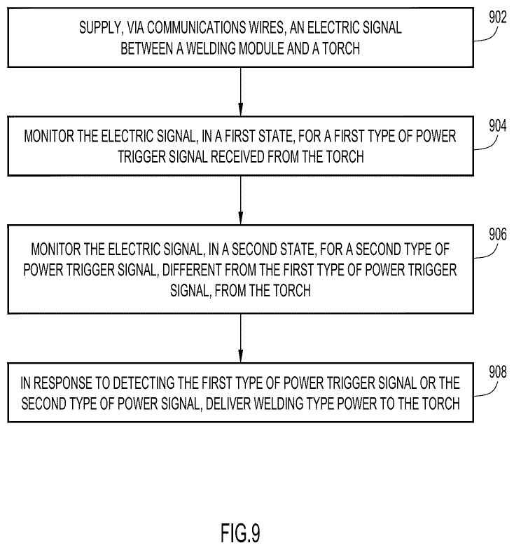

FIG. 9 is flowchart showing a series of operations that may be performed or controlled by the welding system, in accordance with an example embodiment. At 902, an operation includes supplying, via communications wires, an electric signal between a welding module and a torch. At 904, an operation includes monitoring the electric signal, in a first state, for a first type of power trigger signal received from the torch. At 906, an operation includes monitoring the electric signal, in a second state, for a second type of power trigger signal, different from the first type of power trigger signal, from the torch. And, at 908, an operation includes, in response to detecting the first type of power trigger signal or the second type of power trigger signal, delivering welding type power to the torch.

The above description is intended by way of example only. Various modifications and structural changes may be made therein without departing from the scope of the concepts described herein and within the scope and range of equivalents of the claims.

What is claimed is:

1. A method comprising:
supplying, via communications wires, an electric signal between a welding module and a torch;
monitoring the electric signal, in a first state, for a first type of power trigger signal received from the torch;
monitoring the electric signal, in a second state, for a second type of power trigger signal, different from the first type of power trigger signal, from the torch; and
in response to detecting the first type of power trigger signal or the second type of power trigger signal, delivering welding type power to the torch.

2. The method of claim 1, wherein the electric signal is a DC signal.

3. The method of claim 1, wherein the monitoring the electric signal, in the first state, comprises detecting that the electric signal has been shorted.

4. The method of claim 1, wherein the monitoring the electric signal, in the second state, comprises detecting a repetitively modulated signal.

5. The method of claim 1, further comprising electrically powering a human-machine interface of the torch with the electric signal.

6. The method of claim 5, wherein the torch comprises at least one display.

7. The method of claim 1, further comprising superimposing a carrier signal on the electric signal.

8. The method of claim 7, further comprising at least one of transmitting data to, or receiving data from, the torch via the carrier signal.

9. The method of claim 8, wherein the carrier signal is modulated using at least one of on-off keying (OOK), frequency modulation (FM), amplitude modulation (AM), frequency shift keying (FSK), or amplitude shift keying (ASK) to send the data.

10. The method of claim 8, wherein the data comprises at least one of a welding parameter and a software update.

11. The method of claim 1, further comprising, in response to detecting the first type of power trigger signal or the second type of power signal, delivering cutting type power to the torch.

12. An apparatus comprising:
a power source;
a torch; and
communication wires connecting the power source and the torch,
wherein the power source is configured to:
supply, via the communications wires, an electric signal to the torch;
monitor the electric signal, in a first state, for a first type of power trigger signal received from the torch;
monitor the electric signal, in a second state, for a second type of power trigger signal, different from the first type of power trigger signal, from the torch; and
in response to detecting the first type of power trigger signal or the second type of power signal, delivering welding type power to the torch.

13. The apparatus of claim 12, wherein the electric signal is a DC signal.

14. The apparatus of claim 12, wherein the power source is configured to monitor the electric signal, in the first state, by detecting that the electric signal has been shorted.

15. The apparatus of claim 12, wherein the power source is configured to monitor the electric signal, in the second state, by detecting a repetitively modulated signal or a DC signal.

16. The apparatus of claim 12, wherein the power source is further configured to electrically power a human-machine interface of the torch with the electric signal.

17. The apparatus of claim 16, wherein the torch comprises at least one display.

18. The apparatus of claim 12, wherein the power source is configured to superimpose a carrier signal on the electric signal.

19. The apparatus of claim 18, wherein the power source is further configured to at least one of transmit data to or receive data from the torch via the carrier signal.

20. An apparatus comprising:
a power source;
a torch; and
communication wires connecting the power source and the torch,
wherein the power source is configured to:
supply, via the communications wires, an electric signal to the torch to power a human machine interface integrated with the torch;
monitor the electric signal for a power trigger signal represented by a repetitively modulated signal; and
in response to detecting the power trigger signal, delivering welding or cutting type power to the torch.
